(19) United States
(12) Patent Application Publication
(10) Pub. No.: US 2009/0175368 A1
(43) Pub. Date: Jul. 9, 2009

(54) Multiple Resolution Mode Orthogonal Frequency Division Multiplexing System and Method

(76) Inventor: Michael Anthony Pugel, Noblesville, IN (US)

Correspondence Address: Thomson Licensing LLC, P.O. Box 5312, Two Independence Way, PRINCETON, NJ, 08543-5312, US

(21) Appl. No.: 12/227,680

(22) PCT Filed: Jun. 16, 2006
(86) PCT No.: PCT/US2006/023557

§ 371 Date: Nov. 24, 2008

(51) Int. Cl. H04L 27/28

(52) U.S. Cl. 375/260

(57) ABSTRACT

The disclosed embodiments relate to a system and method for processing communication signals. An exemplary method of processing a received orthogonal frequency division multiplexing (OFDM) broadcast signal having a frequency spectrum comprises demodulating the OFDM broadcast signal over a subset of the frequency spectrum to create a first demodulated signal component corresponding to a first signal component the first signal component being representative of a lower resolution version of a second signal component and providing data corresponding to the first demodulated signal component.

### FIELD OF THE INVENTION

The present invention relates to improving the reception of transmitted communication signals, including orthogonal frequency division multiplexed (OFDM) signals in a multi-carrier system.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Manufacturers of wireless communication equipment have a range of transmission technologies to choose from when designing a system or product. Some exemplary technologies are multicarrier systems, spread spectrum systems, narrowband systems, and infrared systems. An exemplary multicarrier transmission technology is orthogonal frequency division multiplexing (OFDM).

OFDM is a robust technique for efficiently transmitting data over a channel having a frequency spectrum. The technique uses a plurality of sub-carrier frequencies (sub-carriers) within a channel bandwidth to transmit data. These sub-carriers are arranged for optimal bandwidth efficiency compared to conventional frequency division multiplexing (FDM), which can waste portions of the channel bandwidth in order to separate and isolate the sub-carrier frequency spectra and thereby avoid inter-carrier interference (ICI). By contrast, although the frequency spectra of OFDM sub-carriers overlap significantly within the OFDM channel bandwidth, OFDM nonetheless allows resolution and recovery of the information that has been modulated onto each sub-carrier.

The transmission of data through a channel via OFDM signals also provides several other advantages over more conventional transmission techniques. Some of these advantages are a tolerance to multipath delay spread and frequency selective fading, efficient spectrum usage, simplified sub-channel equalization, and good interference properties.

Some wireless communication systems, such as satellite systems, employ large reception bandwidths. This makes them unsuitable for difficult reception conditions such as mobile TV or reception in a car.

Additionally, different devices that are intended to receive the same communication signal may have different practical uses, resulting in a need for different levels of “robustness” in terms of signal reception. For example, a high definition television intended for home use will likely need to accurately receive a high resolution signal to function as intended. A mobile television with a small screen may, however, be able to perform effectively with a lower resolution signal. The performance of the mobile television may suffer under difficult reception conditions because it is adapted to receive a high resolution signal that is not really needed for it to function effectively. A system and method that improves the performance of OFDM communications under these circumstances is desirable.

### SUMMARY OF THE INVENTION

The disclosed embodiments relate to a system and method for transmitting and/or receiving communication signals. An exemplary method of processing a received orthogonal frequency division multiplexing (OFDM) broadcast signal having a frequency spectrum comprises demodulating the OFDM broadcast signal over a subset of the frequency spectrum to create a first demodulated signal component corresponding to a first signal component, the first signal component being representative of a lower resolution version of a second signal component, and providing data corresponding to the first demodulated signal component.

An exemplary alternative method comprises encoding a first signal component to create an encoded first signal component, modulating the encoded first signal component across a subset of a frequency spectrum to create a modulated first signal component, encoding a second signal component to create an encoded second signal component, the encoded second signal component comprising data corresponding to the first signal component, and modulating the encoded second signal component across the frequency spectrum to create a modulated second signal component. The alternative exemplary embodiment further comprises transmitting the modulated first signal component and the modulated second signal component as a broadcast signal.

An exemplary system may be adapted to process a received orthogonal frequency division multiplexing (OFDM) broadcast signal having a frequency spectrum. Such a system may comprise a circuit that is adapted to demodulate the OFDM broadcast signal over a subset of the frequency spectrum to create a first demodulated signal component corresponding to a first signal component, the first signal component being representative of a lower resolution version of a second signal component, and a circuit that is adapted to provide data corresponding to the first demodulated signal component.

### BRIEF DESCRIPTION OF THE DRAWINGS

In the drawings:

FIG. 1 is a diagram showing an exemplary format in accordance with which data may be transmitted in an OFDM system;

FIG. 2 is a graph showing an exemplary OFDM transmission waveform;

FIG. 3 is a graph showing an OFDM waveform having a first signal component and a second signal component in accordance with an exemplary embodiment of the present invention;

FIG. 4 is a block diagram of a system for transmitting and receiving OFDM signals in accordance with an exemplary embodiment of the present invention;

FIG. 5 is a process flow diagram illustrating the operation of an exemplary embodiment of the present invention; and

FIG. 6 is a process flow diagram illustrating the operation of an alternative exemplary embodiment of the present invention.

### DETAILED DESCRIPTION OF THE PREFERRED EMBODIMENT

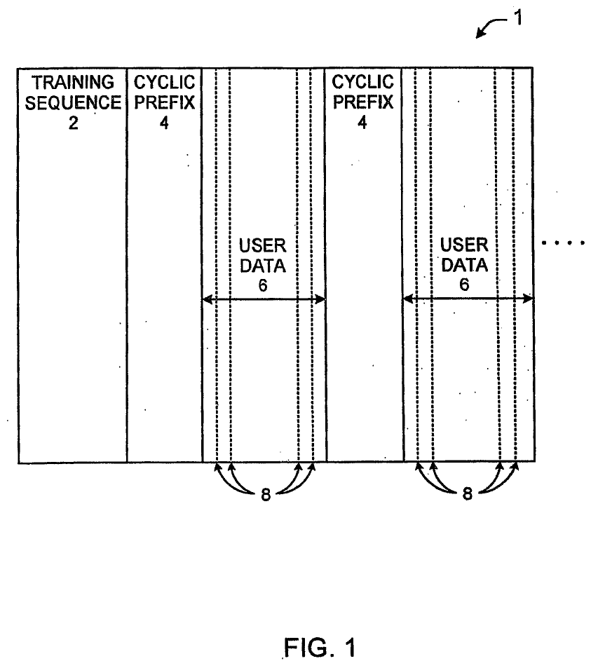

FIG. 1 is a diagram showing an exemplary format in accordance with which data may be transmitted in an OFDM system. An exemplary symbol frame 1 illustrates the use of a training sequence 2, multiple cyclic prefixes 4 and multiple blocks of user data 4. The training sequence or symbol 2 may contain known transmission values for each subcarrier in the OFDM symbol, and a predetermined number of a cyclic prefixes 4 and user data pairs 6. For example, the proposed ETSI-BRAN HIPERLAN/2 (Europe) and IEEE 802.11a (USA) wireless LAN standards, herein incorporated by reference, assigns 64 known values or subsymbols (i.e., 52 non-zero values and 12 zero values) to selected training symbols of a training sequence (e.g., “training symbol C” of the proposed ETSI standard and “long OFDM training symbol” of the proposed IEEE standard).

The user data 6 may comprise a predetermined number of pilots 8, also containing known transmission values, embedded on predetermined subcarriers. For example, the proposed ETSI and IEEE standards have four pilots located at bins or subcarriers ±7 and ±21.

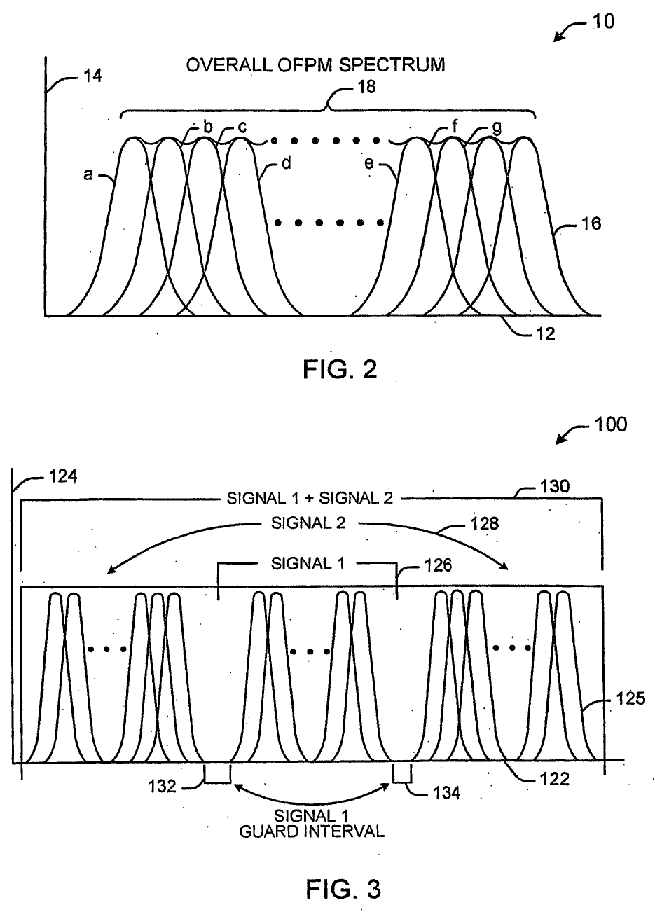

FIG. 2 is a graph showing an exemplary OFDM transmission waveform. The graph is generally referred to by the reference number 10. The graph comprises an x-axis 12, which corresponds to frequency, and a y-axis 14, which corresponds to the amplitude of a signal. The overall OFDM spectrum of the illustrated OFDM channel is indicated by a bracket 18. An OFDM signal 16 comprises multiple subcarriers, identified as a, b, c and so on in FIG. 1. Those of ordinary skill in the art will appreciate that the use of OFDM allows overlapping subcarrier bands (as shown in FIG. 2) to be received and decoded accurately.

FIG. 3 is a graph showing an OFDM waveform having a first signal component and a second signal component in accordance with an exemplary embodiment of the present invention. The graph is generally referred to by the reference number 100. In order to improve reception of a portion of the OFDM spectrum, embodiments of the present invention may include a first signal component and a second signal component, as illustrated in FIG. 3.

The graph 100 includes an x-axis 122, which corresponds to frequency, and a y-axis 124, which corresponds to the amplitude of a signal. An OFDM signal 125 comprises a first signal component, as illustrated by a bracket 126, and a second signal component, as illustrated by an arrow 128. The frequency spectrum of the entire OFDM channel comprises the combination of the first signal component 126 and the second signal component 128, as illustrated by a bracket 130.

An exemplary embodiment of the present invention may be adapted to tune a portion of the frequency spectrum corresponding to the first signal component 126 to improve reception. Reception of the first signal component 126 may be performed in a first mode, while reception of the entire frequency spectrum (corresponding to the first and second signal components 130) may be performed in a second mode of operation. Moreover, the first signal component 126 may be a subset of the second signal component 128.

In the exemplary embodiment illustrated in FIG. 3, the first signal component 126 is separated from the second signal component 128 at either end by a guard band or guard interval, as illustrated by a bracket 132 and a bracket 134. The first signal component 126 may be constructed such that it contains correct OFDM properties, such as a training sequence, a cyclic prefix, pilot signals, the use of 2ⁿ carriers, a guard band that complies with existing standards, and the like.

As shown in FIG. 3, bandwidth associated with the first signal component 126 is smaller than the bandwidth associated with the second frequency component 128. Accordingly, the first signal component 126 may be distributed among a smaller number of carriers than the entire frequency spectrum required for the channel. The smaller signal bandwidth results in improved reception properties.

The second signal component 128 may also employ the carriers in the first signal component 126, with no data. Additional carrier frequencies outside the bandwidth of the first signal component 126 may be employed by the second signal component 128. Accordingly, the total number of carriers for the second signal component 128 (including the first signal component 126) may be a larger power of two than the number of carriers required for the first signal component 126 alone. By way of example, the first signal component 126 may be carried by 64 carriers of which 52 are active, and the second signal component 128 may add an additional 448 carriers (400 active), for a total of 512 carriers (452 active).

The first signal component 126 may comprise a lower resolution version of the information carried by the entire frequency spectrum (the second signal component 128). In this case, embodiments of the present invention may include multiple resolution structures to support scaling, such as the specification(s) of the Joint Video Team (JVT) regarding advanced video coding. In low resolution mode, minimal information may be sent (as for a low resolution display). Additional resolution may be sent in portions of the second signal component 128. This means that hardware adapted to employ lower resolution (e.g. a relatively small video screen) may tune only the first signal component, which would result in improved reception compared to tuning the entire frequency spectrum corresponding to the second signal component. The need for more complex tuning circuitry having a bandwidth reception capability suited to the reception of the entire broadcast frequency spectrum (including the second signal component) is not required in such devices. On the other hand, devices that can usefully employ sufficient bandwidth to accommodate the entire second signal component may nonetheless include alternative circuitry to tune and use only the first signal component under conditions where reception capability is reduced.

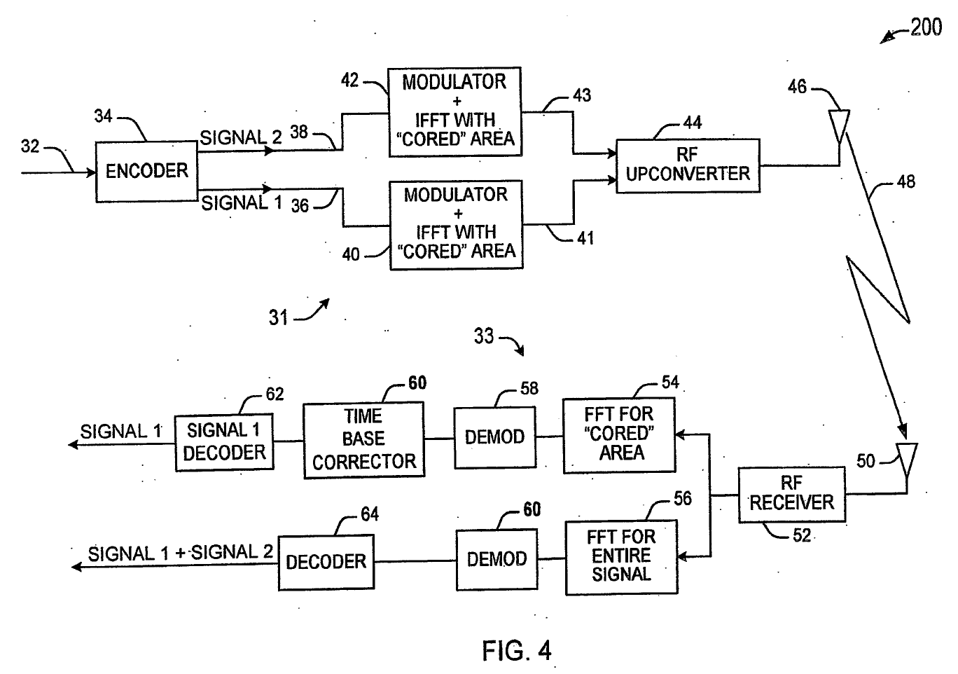

FIG. 4 is a block diagram of a system for transmitting and receiving OFDM signals in accordance with an exemplary embodiment of the present invention. The block diagram is generally referred to by the reference number 200. The functional blocks illustrated in FIG. 4 may be implemented in hardware, software or some combination of both. The functions performed by each block may be split up and performed separately, or incorporated into other functional blocks with other functions.

A transmitter portion of the system is indicated by an arrow 31, and a receiver portion of the system is indicated by an arrow 33. The transmitter portion 31 and receiver portion 33 may be implemented in a single transceiver unit, which would be capable of both sending and receiving OFDM signals.

In the transmitter portion 31, a data stream 32 that is intended to be transmitted is delivered to an encoder 34. The encoder 34 separates the data stream 32 into information corresponding to an encoded first signal component 36 and an encoded second signal component 38. The encoded first signal component 36 and the encoded second signal component 38 may correspond respectively to the first signal component 126 and the second signal component 128 illustrated in FIG. 2. As set forth above, the information that comprises the encoded first signal component 36 may be a subset of the encoded second signal component 38.

The encoded first signal component 36 a modulator and inverse fast forward Fourier transform block 40. As shown in FIG. 3, the portion of the OFDM frequency spectrum represented by the encoded first signal component 36 may be thought of as a “core” of the entire frequency spectrum represented by the encoded second signal component 38. The encoded second signal component 38 is delivered by the encoder 34 to a modulator and inverse fast Fourier transform block 42. The modulator and inverse fast Fourier transform blocks 40 and 42 respectively deliver a modulated first signal component 41 and a modulated second signal component 43 to an RF up-converter block 44. The RF up-converter block 44 is adapted to transmit the information in an OFDM format via an antenna 46.

An OFDM broadcast signal 48 is transmitted from the antenna 46 to a receiving antenna 50 of the receiving portion 33 of the system 200. Upon receipt by the antenna 50, the OFDM broadcast signal 48 is delivered to an RF receiver 52. The RF receiver 52 delivers the signal to a fast Fourier transform block 54 and a fast Fourier transform block 56. The fast Fourier transform block 54 may be adapted to process only the portion of the received frequency spectrum corresponding to the first signal component 126 (FIG. 3). The fast Fourier transform block 56 may be adapted to process information corresponding to the second signal component 128 (FIG. 3).

The fast Fourier transform block 54 delivers output to a demodulator block 58. Because the information processed by the fast Fourier transform block 54 represents a smaller bandwidth of the OFDM frequency spectrum of the channel being transmitted, that signal represents information that has a lower data rate than the entire frequency spectrum. As a result, a sample rate conversion may be needed to properly recover the signal. That sample rate conversion may be performed, for example, by a time base correction block 60, which receives input from the demodulator block 58. The time base correction block 60 then delivers input to a first signal decoder 62. The first signal decoder 62 produces an output signal that corresponds to information contained in the first signal component 126 (FIG. 3).

After processing, the fast Fourier transform block 56 delivers output to a demodulator block 60, which in turn provides an output to a second signal decoder 64. The information processed by the demodulator block 60 and the second signal decoder 64 correspond to the second signal component 128 (FIG. 3), which embodies the entire OFDM frequency spectrum for the channel that was received.

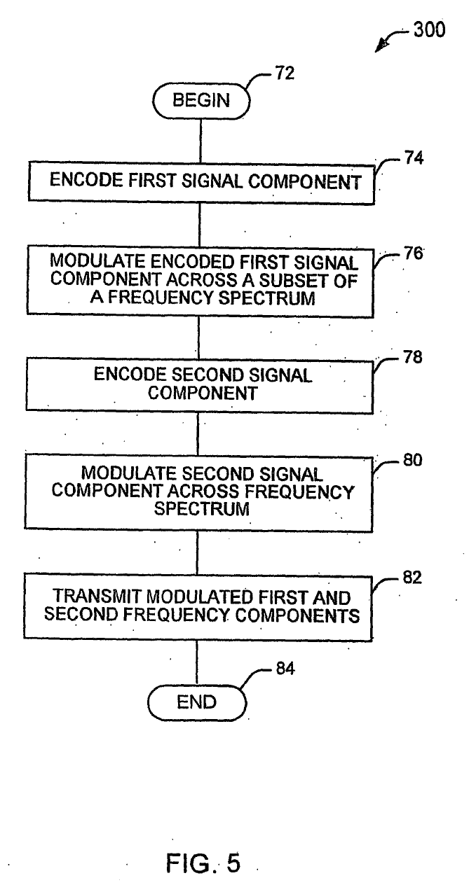

FIG. 5 is a process flow diagram illustrating the operation of an exemplary embodiment of the present invention. The process is generally represented by the reference number 300.

At block 72, the process begins. At block 74, a first signal component is encoded to produce an encoded first signal component, such as the encoded first signal component 36 illustrated in FIG. 4. The encoded first signal component 36 is modulated, as shown at block 76, to produce a modulated first signal component 41. In an exemplary embodiment of the present invention, the modulated first signal component 41 is modulated across a subset of a frequency spectrum prior to transmission as an OFDM broadcast signal 48. As set forth above, the resulting reduction in bandwidth relative to the full frequency spectrum may improve reception characteristics of data corresponding to the first signal component.

At block 78, a second signal component is encoded to create an encoded second signal component 38 (FIG. 4). The encoded second signal component 38 comprises a superset of data corresponding to the first signal component 36 (FIG. 4). At block 80, the second signal component is modulated across the entire frequency spectrum corresponding to the broadcast signal to create a modulated second signal component 43 (FIG. 4). The modulated first signal component 41 and the modulated second signal component 43 are then transmitted as an OFDM broadcast signal 48 (FIG. 4), as shown at block 82. At block 84 the process ends.

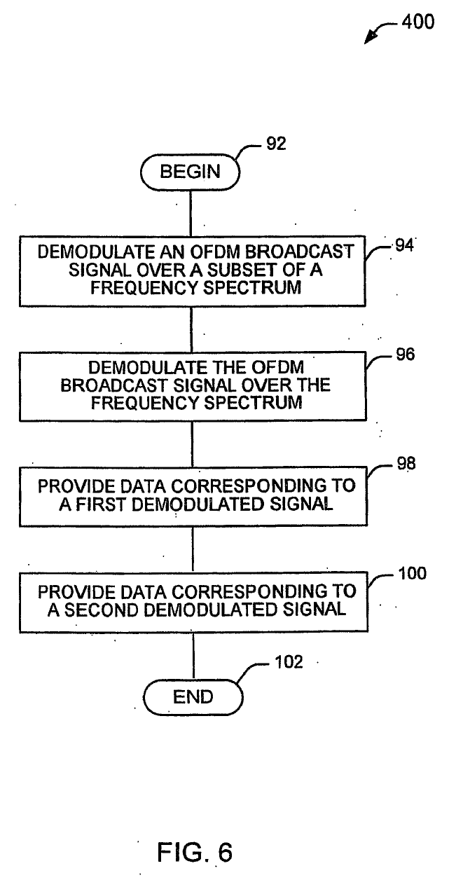

FIG. 6 is a process flow diagram illustrating the operation of an alternative exemplary embodiment of the present invention. The process is generally referred to by the reference number 400.

At block 92, the process begins. An OFDM broadcast signal is demodulated over a subset of its broadcast frequency spectrum, as shown at block 94. The OFDM broadcast signal is also demodulated over the entire broadcast frequency spectrum, as illustrated at block 96. As a result of the demodulation over a subset of the frequency spectrum, data corresponding to a first demodulated signal is provided at block 98. This data corresponds to the first signal component 126 (FIG. 3), which may be a lower resolution version of the data represented by the second signal component 128 (FIG. 3). Additionally, data-corresponding to a second demodulated signal is provided at block 100 as a result of the demodulation of the OFDM broadcast signal over the entire broadcast frequency spectrum (block 96). At block 102, the process ends. As set forth above, a user device that is suitable for displaying a lower resolution may be adapted to have improved reception by tuning only the portion of the broadcast spectrum corresponding to the first signal component.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A method of processing a received orthogonal frequency division multiplexing (OFDM) broadcast signal having a frequency spectrum with a first bandwidths, comprising the steps of:
demodulating the OFDM broadcast signal over a subset of the frequency spectrum to create a first demodulated signal component, and
processing said first demodulated signal component to generate first representation of a video signal.

2. The method recited in claim 1, comprising demodulating the OFDM broadcast signal over the frequency spectrum to create a second demodulated signal component and processing said second demodulated signal component to generate a second representation of said video signal.

3. The method recited in claim 1, wherein the broadcast OFDM signal comprises a plurality of carriers within the frequency spectrum.

4. The method recited in claim 1, wherein the data corresponding to the first demodulated signal component is separated in the OFDM broadcast signal from data corresponding to a second demodulated signal component by at least one guard band

5. The method recited in claim 1, wherein the first representation of the video signal has a lower resolution than the second representation of the video signal.

6. The method recited in claim 1, comprising performing a time base correction on the demodulated first signal component.

7. The method recited in claim 1, wherein the recited acts are performed in the recited order.

8. A method of signal processing, comprising:
encoding a first signal component to create an encoded first signal component
modulating the encoded first signal component across a subset of a frequency spectrum to create a modulated first signal component
encoding a second signal component to create an encoded second signal component, the encoded second signal component comprising data corresponding to the first signal component;
modulating the encoded second signal component across the frequency spectrum to create a modulated second signal component ; and
transmitting the modulated first signal component and the modulated second signal component as a broadcast signal.

9. The method recited in claim 8, wherein the broadcast signal comprises an orthogonal frequency division multiplexing (OFDM) signal.

10. The method recited in claim 8, wherein the broadcast signal comprises a plurality of carriers within the frequency spectrum.

11. The method recited in claim 10, wherein the subset of the frequency spectrum comprises a subset of the plurality of carriers.

12. The method recited in claim 8, wherein the data corresponding to the first signal component (126) is separated in the broadcast signal from data corresponding to the second signal component by at least one guard band.

13. The method recited in claim 8, wherein the data corresponding to the first signal component represents a low resolution version of data corresponding to the second signal component.

14. The method recited in claim 8, comprising performing an inverse fast Fourier transform on the encoded first signal component and the encoded second signal component.

15. The method recited in claim 8, wherein the recited acts are performed in the recited order.

16. A system for processing an orthogonal frequency division multiplexing (OFDM) broadcast signal having a frequency spectrum, the system comprising:
a first circuit that is adapted to demodulate the OFDM broadcast signal over a subset of the frequency spectrum to create a first demodulated signal component corresponding to a first signal component; and
a second circuit that is adapted to provide data corresponding to the first demodulated signal component.

17. The system recited in claim 16, comprising a third circuit adapted to demodulate the OFDM broadcast signal over the frequency spectrum to create a second demodulated signal component that corresponds to a combination of the first signal component and a second signal component.

18. The system recited in claim 16, wherein the data corresponding to the first demodulated signal component represents a low resolution version of data corresponding to a combination of the first signal component and a second demodulated signal component.

19. The system recited in claim 16, comprising a third circuit that is adapted to perform a time base correction on the demodulated first signal component.

20. The system recited in claim 16, wherein the data corresponding to the first demodulated signal component is separated in the OFDM broadcast signal from data corresponding to a second demodulated signal component by at least one guard band
